(19) United States
(12) Patent Application Publication
(10) Pub. No.: US 2006/0206432 A1
(43) Pub. Date: Sep. 14, 2006

(54) Digital rights management using network topology testing

(76) Inventors: John Christopher Park Russell, San Diego, CA (US); Jim C. Williams, Yorba Linda, CA (US)

Correspondence Address: CONNOLLY BOVE LODGE & HUTZ LLP, P.O. BOX 2207, WILMINGTON, DE, 19899, US

(21) Appl. No.: 11/266,831

(22) Filed: Nov. 3, 2005

Related U.S. Application Data
(63) Continuation-in-part of application No. 10/998,030, filed on Nov. 24, 2004.
(60) Provisional application No. 60/624,829, filed on Nov. 3, 2004.
(60) Provisional application No. 60/525,651, filed on Nov. 26, 2003.

(51) Int. Cl. G06Q 99/00

(52) U.S. Cl. 705/57

(57) ABSTRACT

A method and system for preventing unauthorized use of copyrighted digital information over a broadband network includes testing network topology between a source and recipient device. Testing may include transmitting well-crafted information packets for transmission between source and recipient, and evaluating network response to gain information about the topology of the connecting network. Key components for using digital content, or the content itself, may be placed in a package that will not be transmitted by unauthorized network devices. Authorization or capability to use or receive the digital content is based at least in part on network topology between the source and recipient device.

### CROSS-REFERENCE TO RELATED APPLICATION

This application claims priority pursuant to 35 U.S.C. § 119(e) to U.S. Provisional Application No. 60/624,829, filed Nov. 3, 2004, and is a continuation-in-part of application Ser. No. 10/998,030, filed Nov. 24, 2004, which claims priority to U.S. Provisional Application No. 60/525,651, filed Nov. 26, 2003. All of the foregoing applications are specifically incorporated herein, in their entirety, by reference.

### BACKGROUND OF THE INVENTION

1. Field of the Invention

The present invention relates to a method and system for controlling distribution of digital copyrighted material over a broadband connection, based on a determination of network topology between the source device and a receiving device requesting content over a broadband network.

2. Description of Related Art

Recent developments in broadband technology have enabled cost-effective distribution of high-value content over a broadband network, both locally and remotely. For example, the increasingly wide availability of “plug-and-play” technology allows a broad range of consumer electronic devices to be easily connected into digital cable networks. The set-top boxes of the past might thus be converted into distribution nodes of a broadband network. However, these increases in efficiency of broadband communication, along with the growing utilization of networked systems in and between homes, offices, and other locations, have also increased the threat of remote redistribution of digital content from paying to non-paying clients via the broadband connection. Fear of illegal and rampant copying and re-distribution of digital content over networked systems may prevent TV and movie providers from utilizing this method of transmission for their content. In order to take advantage of broadband distribution, new content protection and copy management systems should ensure the content cannot be redistributed to another customer or another location using a broadband distribution network.

It may also be desirable to prevent digital content from being redistributed out of a defined geographic area, for example when broadcasted content is distributed in digital form. Traditional business models regarding licensing and distributing content over a broadcast network are typically based on location or geographic area. TV is licensed on a conditional access model, according to Designated Market Areas (DMAs) which are based on Nielsen defined geographic regions. For example, a Los Angeles television station is not licensed to broadcast to a New York audience. Pay-per-view television also has rules defining limited rights to content based on geographic scope, such as a subscription limited to a house or to homes within a specific region.

Mere re-broadcasting or redistribution of a content signal over a broadband network may not require any copying of content. Thus, traditional copy-protection methods focused on preventing copying of the content may not effectively prevent redistribution or rebroadcast of such content.

It is desirable, therefore to provide a method and system for determining with reasonable confidence a relative proximity of any networked device receiving copyrighted digital content over a network. It is further desirable to make use of information regarding a networked device's relative proximity to one or more other networked devices in a system for digital rights management.

### SUMMARY OF THE INVENTION

The present invention provides a system and method for controlling distribution of copyrighted digital content base on a determination of network topology between a source device and receiving device. The topological information can then be used to determine whether the receiving device is authorized for access to that content.

In an embodiment of the invention, information concerning intervening network topologies may be determined from messages exchanged between a transmitting and a receiving device. Topology indicative of relative proximity may be determined by detecting specific network components installed between two devices: hubs, switches, routers, tunnels, VPN gateways and other network devices.

Network components may be detected by sending specific, well-crafted packets that are processed differently by different components. For example, packets with a valid layer-2 MAC header but invalid layer-3 Network header will be retransmitted by switches but not by routers. Often, switches and hubs are used in local, in-home networks, while routers and VPN gateways are used in wide-area networks (WAN's), such as the Internet. In an embodiment of the invention, therefore, content may be restricted or distributed depending on whether or not a router or VPN gateway is detected between the source device and a receiving device.

The use of well-crafted packets provides advantages over alternative methods of determining network topologies, and may provide more robust and practical methods for detecting network components and determining relative proximity. For example, pinging or port scanning network addresses can only detect components that are configured to respond to pings or port scans, nor can it determine which components are used to transmit traffic between two end points. Network sniffing can be used to monitor each network segment for routing and management protocols, such as RIP, OSPF, BGP, SNMP, RGMP, CGMP, HSRP, VRRP, STP, and so forth. However, such monitoring requires a network sniffing component to be installed on each network segment, which is infeasible for wide-area networks such as the Internet, and will not detect the majority of switches, VPN devices, or statically-configured routers. A further technique transmits packets with a small time-to-live (TTL) value, such as 1. This type of packet will bounce when it encounters a router, but this technique cannot be used to detect switches, VPN's and other forms of network encapsulation. Well-crafted packets may overcome these limitations by more effectively determining the presence of certain network components and obviate the need for sniffing components.

In an embodiment of the invention, a sequence of well-crafted packages may be transmitted, some or all of which may result in a return package or handshake. Two or more of the packages may be crafted to respond differently to different network components. The response of the network to the sequence of packages may provide more detailed or more accurate information than can be obtained by evaluating a response to a single package.

In an embodiment of the invention, a key component is provided in a package that is crafted so as to not be transmitted over prohibited network topologies. For example, a package may be crafted so that it cannot be routed using a router or VPN gateway. The key component may comprise any component that is needed to make use of transmitted content, such as, for example, a decryption key or password. In the alternative, or in addition, any portion of the controlled content may be transmitted in packages that will not be routed or otherwise not delivered using prohibited devices.

In an embodiment of the invention, relative proximity between network devices may be computed, without regard for geographic proximity. For example, if a router or VPN gateway is detected between a source and recipient device, the content may be restricted from the recipient device, regardless of geographic distance between the source and the recipient. In other embodiments, some combination of estimated geographic proximity and relative network proximity may be used to determine eligibility to receive content.

Characteristics of certain topographies, including for example responses to well-crafted packages or typical transmission times, may be stored in a secure, updateable table. The table may be consulted in lieu of, or in addition to, performing an evaluation of relative proximity immediately prior to transmitting controlled content. Information in the table may be updated periodically.

A more complete understanding of the relative proximity-determining method will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a block diagram showing an exemplary system according to the invention.

FIG. 2 is a flow chart showing exemplary steps of a method for preventing unauthorized access to copyrighted digital information.

FIG. 3 is a flow chart showing exemplary steps of a method for preventing unauthorized access to copyrighted digital information, according to an alternative embodiment of the invention.

FIG. 4 is a flow chart showing exemplary steps of a method for evaluating a transmission path according to the invention.

FIG. 5 is a flow chart showing exemplary steps for circumventing a digital rights management method based on topology testing.

### DETAILED DESCRIPTION OF THE PREFERRED EMBODIMENT

The present invention provides a method and system for determining the geographic location of a network device, or relative proximity of a interconnected devices, and use of such information for digital rights management over a network, that overcomes the limitations of prior art. In the detailed description that follows, like element numerals are used to describe like elements appearing in one or more of the figures.

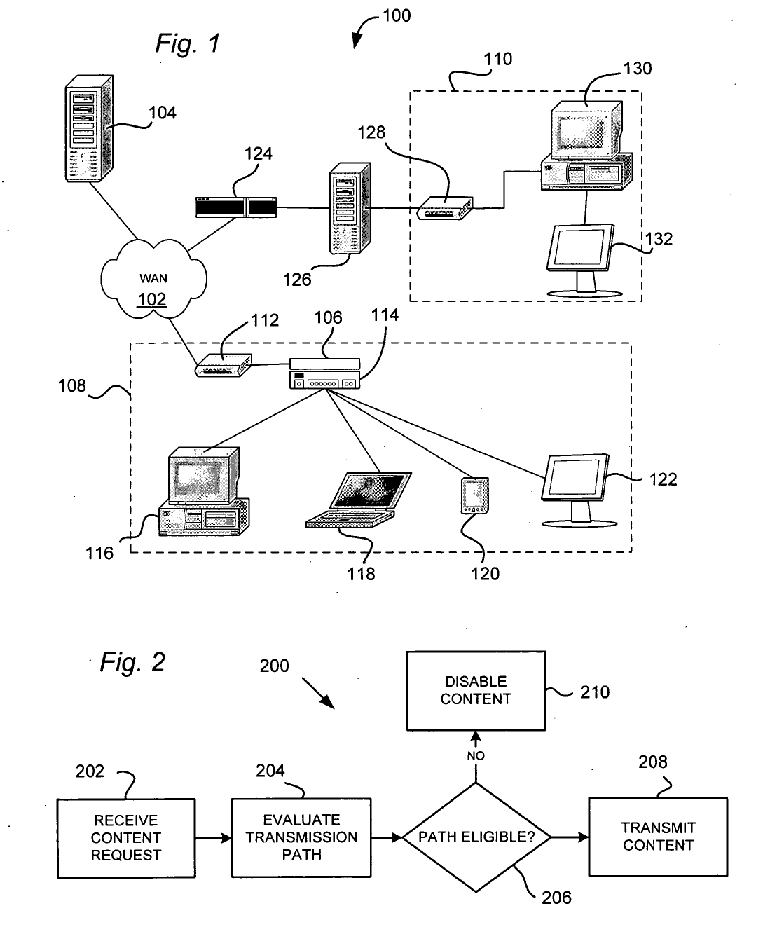

FIG. 1 shows a system 100 comprising a wide area network 102, such as the Internet, and an exemplary local area network 108 connected to WAN 102. Local area network 108 may comprise various components, at least one of which is used for viewing or listening to digital content such as movies, television or radio programs, music, electronic books, photographs, or any other content such as may be put in digital form and distributed commercially. System 100 may comprise a server 104 connected to LAN 108 via WAN 102 for distribution of digital content. In the alternative, or in addition, digital content may be provided to LAN 108 from non-networked sources, for example, DVD or CD optical disks, magnetic media, satellite receivers, cable television receivers, and so forth. System 100 may further comprise numerous other end-user devices 130, 132 which may be connected in numerous other local area networks such as LAN 110 (one of many shown). It should be appreciated that system 100 and WAN 102 may comprise numerous network components, for example router 124 and server 126.

LAN 108 may comprise a variety of different devices for receiving, using, storing, processing, or transmitting digital content, for example, personal computers 116 and 118, portable media player 120, display set-top boxes, digital television (DTV) receivers, a broadband modem 112 or other device for connecting to WAN 108 via copper cable, fiber optic cable, wireless connection, or other connection. In one embodiment, LAN 108 comprises a cable modem or set-top box (not shown) receiving digital content from a cable or satellite network. These devices for receiving, using, storing, processing or transmitting digital content may be connected via one or more hubs, such as hub 114. In the alternative, or in addition, devices may be connected in a peer-to-peer network or other suitable LAN topology with or without hubs.

In an embodiment of the invention, LAN 108 may be equipped with a Topology Detection for Digital Rights Management (TD-DRM) device 106. A TD-DRM device may comprise any suitable device, appliance, component, software, or firmware operative to perform or facilitate proximity detection and digital rights management steps according to the invention. The TD-DRM device may be implemented as a stand-alone device, or as a component of another network device, for example a hub 114 or a computer 116. The TD-DRM device 106 may reside on or be associated with different network devices in LAN 108, or may be associated with a single device as shown. The TD-DRM device 106 may be implemented as software or firmware for execution on general-purpose computers, special-purpose consumer electronics devices, or other devices. In the alternative, or in addition, a TD-DRM device may be implemented using digital electronics cards, printed circuit boards, or adaptors that attached or plug into other devices. All or portions of TD-DRM device functionality may be implemented in application-specific integrated circuits (ASICs), field-programmable gate arrays (FPGAs) or other electronic and chip devices. TD-DRM device 106 may also comprise a plurality of distributed components or modules that cooperate to perform TD-DRM device functions.

According to an embodiment of the invention, a digital rights control scheme may operate on the principle that certain copyrighted digital content may be freely distributed within an authorized user's local area network 108, but distribution outside of the local area network may be limited, prohibited, or subject to additional license fees as needed to protect the interests of the copyright holders and prevent copyright piracy. For example, certain content may be purchased and freely used on consumer devices belonging to the user's home network, such as on the user's media display devices 122, personal computers 116, 118, and portable electronic devices 120. However, distribution of content to another household may be prohibited. For example, a satellite or cable subscriber may be permitted to view or record copyrighted content on any device for personal or household use, but should not be permitted to share the content with another household operating its own LAN 110, nor should the subscriber be permitted to upload digital content to a network server 126. Methods for using proximity detection for digital rights management in such contexts and for such uses are described below.

Referring to FIG. 2, exemplary steps of a method 200 for digital rights management using network topology detection are shown. At step 202, a request to transmit digital content to an identified network location is received. The request may be intercepted by a TD-DRM device between an originating device, such as a computer 116, and a network connection device 112 or other portal to WAN 102, or anywhere within local area network 108. In the alternative, or in addition, the TD-DRM function may be implemented as a component or accessory of the originating device. For example, TD-DRM functionality may be implemented in software used for transmitting files to addresses within a network, such as, for example, e-mail software or application software for file transfers or streaming media. In an embodiment of the invention, the TD-DRM function may first check a transmission request for copyrighted content before implementing a topology detection routine.

At step 204, network topology between the TD-DRM function and the designated recipient is evaluated by sending a well-crafted information packet to the recipient, and evaluating a resulting response. Details concerning an exemplary methods of topology detection are provided below in connection with FIG. 4. At step 206, an eligibility determination is made based on the response. For example, if the response, or lack of a response, indicates that the transmission pathway includes elements of a wide area network, then the path may be deemed ineligible for transmission of the content. Conversely, if the response or lack of a response indicates that the transmission pathway does not include elements of a wide area network, then the path may be deemed eligible for transmission of the content. It should be apparent that any desired criteria may be applied to distinguish eligible from ineligible pathways, and the criteria for eligibility may evolve with changes in consumer behavior and the development of new technology.

At step 208, the content is transmitted to the recipient device if the transmission pathway is deemed eligible. At step 210, the content is disabled if the transmission pathway is not deemed eligible. Disabling may comprise, for example, preventing transmission of all or a portion of the controlled content, or transmitting the content in an unusable form, such as in an encrypted form without a decryption key.

In alternative embodiments, some combination of estimated geographic proximity and relative network proximity may be used to determine eligibility to receive content, such as at step 204 of method 200. Geographic distance may be used as a factor in combination with measured transmission topography. For example, a switch may be allowed but only if the recipient device is within a define geographic distance of the source device. Mixed determinations using geographic distance as a factor may be appropriate for more sophisticated content subscribers with more complex local networks. For example, content may be permitted for distribution over an intranet on a corporate or university campus, but not for off-campus distribution.

A determination of distance may include, for example, a secure time function to determine a time at which a message containing a cryptographically unique identifier is sent to the requesting device. The message may be sent via any one of a variety of known secure methods of communication. The requesting device receives the message, modifies it with its own cryptographically unique identifier and returns the message to the source device via a known secure method of communication. Once the source device receives the reply message, it confirms that it is sent in response to the message originally sent and that the message could only have been modified by the requesting device, based on the unique identifiers. Then the source device measures the elapsed time between sending the original message and receipt of the reply, and uses a secure, updatable table of network characteristics with the measured time to determine a probability that the receiving device is local or close distance, medium distance or a long distance from the source device. Based on this determination of relative distance and the allowed geographic range for the requested content, the source device may either permit or deny access to the requested content.

Additionally or alternatively, the receiving device may also use a secure time function to stamp the message at the time it is received from the source device. Upon receiving and authenticating the reply message, the source device can simply measure the time differential between the time sent by the source and the time received by the receiving device. This time difference may also be used with information concerning network characteristics to determine the relative proximity of the receiving device. In addition, or in the alternative, a message transit time for the reply message may also be used to determine a device proximity.

It should be apparent that geographical location information may also be obtained by other methods, for example such as described in the parent application Ser. No. 10/998,030. Further, in an embodiment of the invention, an eligibility estimate may be expressed in a probabilistic manner. For example, “there is a 95% certainty that the device is eligible to receive this content” represents a simple probabilistic estimate of eligibility. According to an embodiment of the invention, a user may define a desired level of certainty as a threshold required before action is taken by a source device. For example, a 95% confidence that a device is eligible may be required. In addition, a definition of “eligible” can be set by the source device according to any desired value of various parameters. Once a device is determined to be eligible, then the source device can perform a transaction that is contingent on eligibility, such as transmitting video content.

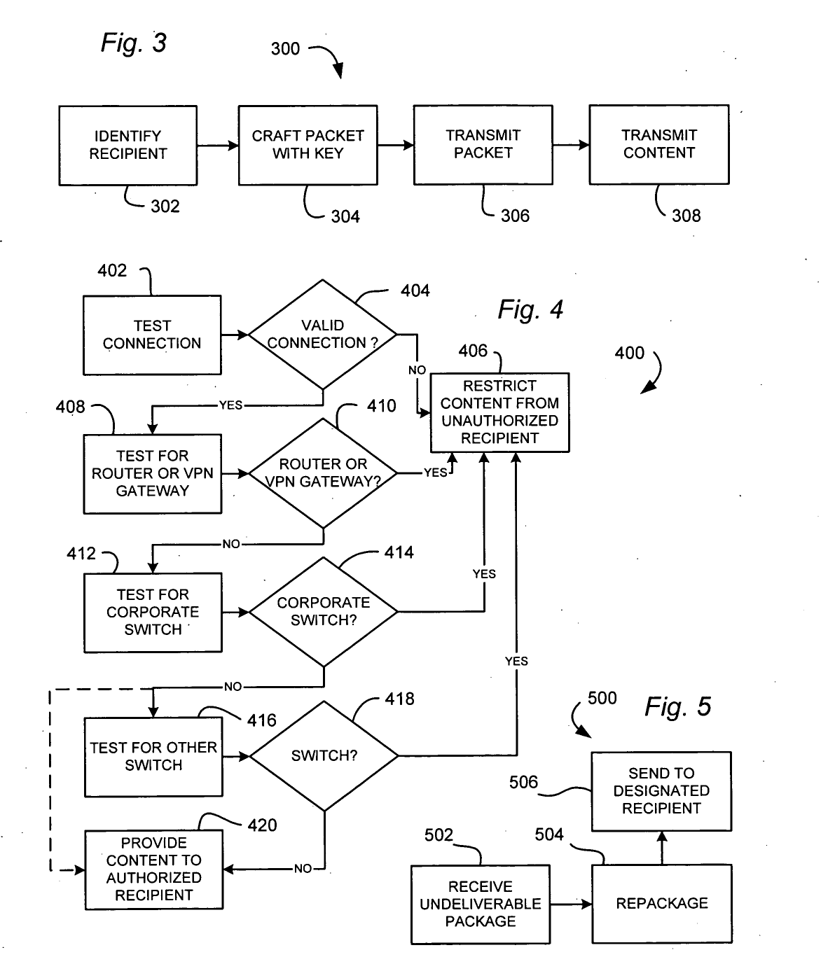

In an embodiment of the invention, the step of evaluating the transmission pathway may essentially be collapsed into the steps of transmitting and disabling content, using an alternative method 300 shown in FIG. 3. In method 300, key portions of the protected content are transmitted in a package that cannot be transmitted over prohibited topologies. At initial step 302, a request to transmit digital content to an identified network location is received. As in method 200, this step may be performed at any point prior to transmitting content over a prohibited topology. At step 304, an information packet comprising a key component of the content, such as a decryption key or password, is created and addressed to the designated recipient. The packet is well-crafted so as to be not transmissible by a prohibited network component. For example, the packet may be non-routable or include unknown or invalid layer-3 information. Such packets will be transmitted by a hub to other devices in a local area network, but will not be transmissible via a router, VPN layer, or certain types of switches. Further details concerning well-crafted packets are provided in the discussion below. The key component is not limited to a decryption key or password, and may comprise any information needed to enable use of the controlled content. In an embodiment of the invention, the protected content is placed entirely in well-crafted packets as described herein. However, limiting well-crafted packets to serve as carriers of key components is believed to be a more efficient and therefore usually more desirable approach when the key system is adequately secure.

At step 306, the well-crafted packet with the enabling component is transmitted to the designated recipient. However, it is not received by the recipient if the transmission makes use of any prohibited network device or topology. Conversely, if no prohibited devices are involved in the transmission, the well-crafted packet and its key component are received by the intended recipient device. Step 306 may comprise sending all necessary parts of a key component in a single well-crafted packet. In the alternative, more than one well-crafted packet may be transmitted, each containing a different key component or portion of a key component. In such case, the well-crafted packets may be configured to not be transmittable by different prohibited network devices, so that if any one of such prohibited devices are present in the transmission path, all key components are not received and the content cannot be used by a recipient device outside of the permitted topographical area.

At step 308, any remaining portions of the content are transmitted to the recipient. Any form of packet may be used, as the content will not be usable unless the key component has also been received. In the alternative, steps 304 and 306 may be omitted, and content may be transmitted entirely or substantially entirely in well-crafted packets, which can be received only by devices with the permitted local area network or other permitted topological region.

To detect and evaluate the network topology between two devices, the devices may transmit or exchange a series of well-crafted packets called test packets. FIG. 4 shows exemplary steps of a method 400 for evaluating a network topography. It should be appreciated that while method 400 comprises transmitting a series of test packets, transmitting as few as one test packet is also within the scope of the invention. In addition, transmission of a different number of test packets, or different types of test packets from those shown in FIG. 4 are also in the scope of the invention. Furthermore, examples of well-crafted packets as described below may also be useful for transmitting key components according to steps 304 and 306 of method 300.

Several methods and options may be used for exchanging test packets generally. In the alternative, or in addition, single packets may be sent without proviking a response packet. A “two-way handshake” may be used to test traffic in one direction, from source ‘A’ to recipient ‘B.’ Device ‘A’ begins by sending a particular test packet to ‘B.’ If or when ‘B’ receives the packet, it replies to ‘A’ with a corresponding response packet. Device ‘A’ draws no conclusions from the test until it receives the response packet.

A “three-way handshake” may be used to test traffic in both directions between the source and recipient. Device ‘A’ begins by sending a particular test packet to ‘B.’ If or when ‘B’ receives the packet, it replies to ‘A’ with a corresponding “test+response” packet. If or when ‘A’ receives the test+response packet, it replies to ‘B’ with a corresponding response packet. Device ‘A’ draws no conclusions from the test until it receives the test+response packet, and device ‘B’ draws no conclusions until it receives the response packet.

Either of the foregoing handshakes may use HMAC authentication, in which the two devices ‘A’ and ‘B’ share a common HMAC cryptographic key. The test packet's data payload may contain a nounce value (‘n’) encrypted using the HMAC key {n}_{HMAC}. The recipient device, if able to decrypt the nounce, replies with an {n+1}_{HMAC} (or other predesignated altered nounce value) in the test+response packet or the response packet, as the case may be. Other challenge/response procedures may also be suitable. Likewise, authentication may make use of PKI authentication, in which each of the devices knows the other devices' public key but not the private key. The data packets contain a nounce value or altered nounce value according to the predesignated challenge/response protocol, which are decrypted by the recipient device using the PKI public key.

Test packets may contain a copyrighted work followed by a copyright notice. For example, “Haiku, I hate you. You're so hard to do. ©2003 Author unknown.” The copyright notice and work may be defined in the header rather than in the data (layer 7) portion of the packet. Thus, the copyrighted work may be made part of the test protocol itself. A device may check the validity of a test packet by checking the value of its copyright works and notice against an expected value. The device may require a license by the copyright holder to legally copy or retransmit the packet. This may include retransmission by routers, VPN gateways and other network components. In the alternative, or in addition, copyrighted works may be provided in the data portion of the packet only.

FIG. 4 illustrates a deductive method by which specific network components can be detected. The illustrated steps may be performed in any operative order, and may be combined in fewer than the illustrated number of steps. At step 402, network connectivity is tested by exchanging any form of standard network communication, such as a ping packet according to TCP/IP (i.e., a TCMP Request/Reply packet), a Netware ping packet, or an Appletalk ping packet. Other useful protocols and communications may include UDP datagrams, TCP handshake, IPX/SPX, NetBEUI, and so forth. If a return packet is not received, then the devices are disconnected, or separated by a firewall. Devices that are separated by a firewall may be deemed to reside in different local environments, and transmission of content between different local networks may be generally not desirable in contemplated DRM schemes. Hence, at steps 404 and 406, content is restricted or disabled if tests indicate that a valid connection is not present between the source and recipient devices.

At step 408, a test for a router or VPN gateway may be performed by exchanging test packets using a non-routable protocol, such as, for example, UDP broadcasts, NetBEUI, or Appletalk. Routers do not retransmit these test packets unless specifically configured to do so, and such packets therefore cannot be transmitted across a massive public wide area network such as the Internet. Switches and hubs, in comparison, generally always transmit these test packets. A VPN gateway can be configured either way, and may retransmit these packets across the Internet using protocol encapsulation.

Therefore, a test for routers and VPN gateways may, in the alternative or in addition to non-routable packets as described above, comprise exchanging packets having unknown layer-2 network protocols. Two examples of test packets using unknown layer-2 network protocols are provided below:

Ex. 1: Using Ethernet II frame.

| | |
|---|---|
| Bytes 0:5 | Destination MAC address |
| Bytes 6:11 | Source MAC address |
| Bytes 12:13 | Protocol number 0xCBBC |
| Bytes 14:n | Copyright works and notice |
| Bytes n+1:end | Layer-7 data field |

Ex. 2: Using 802.2 LLC frame

| | |
|---|---|
| Bytes 0:5 | Destination MAC address |
| Bytes 6:11 | Source MAC address |
| Bytes 12:13 | Packet length |
| Byte 14 | 0xBC |
| Byte 15 | 0xCB |
| Byte 16 | 0xFF |
| Bytes 17:n | Copyright works and notice |
| Bytes n+1:end | Layer-7 data field |

These test packets will be retransmitted by hubs and switches, but not by routers and VPN gateways. The second example is likely to be the most effective in detecting routers and VPN gateways that are configured to retransmit as many protocols and packets as possible.

Another method for detecting routers comprises exchanging test packets with an invalid checksum in the network or transport layer, such as the 16-bit header checksum of an IP packet or the 16-bit TCP or UDP packet, respectively. Similar invalid checksums may be used for the network (layer 2) and transport (layer 3) layers of other protocols, including but not limited to Netware SPX/IPX, AppleTalk, SNA, and other protocols.

At steps 410 and 406, if a router or VPN gateway is detected, the content may be restricted or disabled, as the transmission is likely to involve use of the Internet to a remote location.

At step 412, a test for a high-end corporate switch may be performed. More sophisticated switches as used in corporate networks often validate the CRC checksum in the Ethernet frame. Therefore, to test for switches with validation capabilities, a test packet with an invalid CRC checksum may be used. A router, VPN gateway, and validating switch will reject these test packets, while a less-sophisticated switch, such as a consumer-grade switch or hub, will retransmit them. At steps 414 and 406, content is restricted if a corporate (checksum validating) switch is detected. If no corporate switch is detected, content may be provided to the recipient device at step 420. In the alternative, an additional layer of testing may be performed at step 416.

Testing for a switch at step 416 may be performed by exchanging packets characterized by a partial or invalid layer-1 frame, or a unicast packet addressed to the transmitting device, such that it would not be routed across a switch. Examples of these packets are provided below:

Ex. 3: Invalid Ethernet II frame.

| | |
|---|---|
| Bytes 0:5 | Source (not destination) MAC address |
| Bytes 6:11 | Source MAC address (same as preceding bytes 0:5) |
| Bytes 12:13 | Protocol number = 0xCBBC |
| Bytes 14:n | Copyright works and notice |
| Bytes n+1:end | Layer-7 data field |

Ex. 4: Incomplete Ethernet II frame.

| | |
|---|---|
| Bytes 0:3 | 0x1234 |
| end | (no more bytes in this packet) |

Both of these packets will be transmitted by hubs in a local area network, but not switches, routers, or VPN gateways. At steps 418 and 406, content may be restricted from the recipient if a switch is detected. If no switch is detected, content may be provided to the presumably authorized receiving device. It should be apparent that the specific test methods described in connection with FIG. 4 are merely exemplary. Other test packets or other testing sequences may be devised to evaluate network topography between a source and recipient device, without departing from the scope of the invention. In addition, a variation of method 400 may be applied to collections of devices rather than pairs of devices at a time. Collections may be evaluated through trust chains, exchange of certificates, broadcasting and multicasting, and other techniques.

Although circumvention of digital content protection is neither condoned nor legal, tremendous economic incentives exist for theft of copyrighted content and such inventive may compel some to devise and construct a system for circumventing the digital rights management methods disclosed herein. A circumvention device may be constructed to retransmit a test packet although the device would not normally do so. For example, a router or VPN gateway may be built that encapsulates or otherwise retransmits the unknown or unroutable protocols used by test packets as disclosed herein.

As shown in FIG. 5, such a router or other circumvention device may employ a circumvention method 500. At step 502, the device receives an unroutable or otherwise undeliverable packet. At step 504, the device repackages the undeliverable packet in a deliverable format. For example, unroutable packets may be repackaged and addressed to a designated diversion address. A device may be provided at the diverted address to simulate the response of the original recipient. In the alternative, or in addition, the system may be configured such that the router or other circumvention device is supplied with the address of the intended recipient. During repackaging, errors in the header information are simply corrected and the packet is therefore able to be routed as a normal packet.

At step 506, the packet is routed or retransmitted to the designated recipient. In case the packet is diverted to a different recipient as a result of the repackaging, the diverted recipient may be configured to provide a response packet to the source as described herein. If necessary, an intervening circumvention device may intercept and modify the response packet to hide any indication that the test protocol is being circumvented. The source may thereby not be able to detect the prohibited topography and may transmits enabled digital content to an unauthorized recipient. It should be noted that combining topographical testing with other methods, for example, geographic location testing, may make the digital rights management method of the invention more difficult to circumvent.

The foregoing circumvention devices and methods are within the scope of the invention. However, the use of the circumvention devices or methods is neither condoned nor encouraged. Those of skill in the art should obey the law and not circumvent or disable copyright protection schemes for digital content.

Having thus described a method and system for controlling access to digital content based on topography of a transmission pathway, it should be apparent to those skilled in the art that certain advantages of the within system have been achieved. It should also be appreciated that various modifications, adaptations, and alternative embodiments thereof may be made within the scope and spirit of the present invention. For example, a system wherein the requesting device is a set top box has been illustrated, but it should be apparent that the inventive concepts described above would be equally applicable to other types of television devices, music devices, computing devices, personal assistants and other similar devices. In addition, the system can be used to control the flow of any type of communication where absolute or relative geography and proximity are determinative. The invention is defined by the following claims.

What is claimed is:

1. A method for preventing unauthorized use of copyrighted digital information comprising the steps of:
transmitting a test packet from a source to a receiving device for copyrighted digital information, the test packet being crafted so as to be not transmittable by a prohibited device;
disabling use of the copyrighted digital information by the receiving device if the test packet is not successfully transmitted to the receiving device.

2. The method of claim 1, further comprising waiting to receive a response packet from the receiving device.

3. The method of claim 2, further comprising evaluating a transmission path between the source and the receiving device, based on whether or not the response packet is received from the receiving device.

4. The method of claim 3, wherein the evaluating step further comprises measuring an elapsed time between the transmitting of the test packet and a time that the response packet is received.

5. The method of claim 4, wherein the disabling step is further conditioned at least in part on the elapsed time measured in the evaluating step.

6. The method of claim 1, further comprising transmitting the test packet in a series of test packets, ones of the series of test packets configured so as to be not transmittable by a different prohibited device.

7. The method of claim 6, further comprising evaluating a transmission path between the source and the receiving device, based on whether or not response packets are received from the receiving device in response to the series of test packets.

8. The method of claim 1, wherein the disabling step comprises placing at least a portion of the copyrighted digital content in the well-crafted packet.

9. The method of claim 1, wherein the disabling step comprises placing a key component for accessing the copyrighted digital content in the well-crafted content.

10. The method of claim 1, wherein the transmitting step comprises transmitting the well-crafted packet comprising a ping packet.

11. The method of claim 1, wherein the transmitting step comprises transmitting the well-crafted packet comprising a non-routable packet.

12. The method of claim 1, wherein the transmitting step comprises transmitting the well-crafted packet selected from the group consisting of: an unknown layer-3 packet, an invalid layer-3 CRC packet, and a unknown layer-2 packet.

13. A system for preventing unauthorized use of copy-protected content, comprising:
a processor operable to execute program instructions;
a memory operably associated with the processor, the memory holding the program instructions comprising:
transmitting a test packet from a source to a receiving device for copyrighted digital information, the test packet being crafted so as to be not transmittable by a prohibited device;
disabling use of the copyrighted digital information by the receiving device if the test packet is not successfully transmitted to the receiving device.

14. The system of claim 13, wherein the program instructions further comprise waiting to receive a response packet from the receiving device.

15. The system of claim 14, wherein the program instructions further comprise evaluating a transmission path between the source and the receiving device, based on whether or not the response packet is received from the receiving device.

16. The system of claim 14, wherein the evaluating step of the program instructions further comprises measuring an elapsed time between the transmitting of the test packet and a time that the response packet is received.

17. The system of claim 14, wherein the program instructions further comprise conditioning performance of the disabling step at least in part on the elapsed time measured in the evaluating step.

18. The system of claim 12, wherein the program instructions further comprise transmitting the test packet in a series of test packets, ones of the series of test packets configured so as to be not transmittable by a different prohibited device.

19. The system of claim 16, wherein the program instructions further comprise evaluating a transmission path between the source and the receiving device, based on whether or not response packets are received from the receiving device in response to the series of test packets.

20. The system of claim 13, wherein the disabling step of the program instructions further comprises placing at least a portion of the copyrighted digital content in the well-crafted packet.

21. The system of claim 13, wherein the disabling step of the program instructions further comprises placing a key component for accessing the copyrighted digital content in the well-crafted content.

22. The system of claim 13, wherein the transmitting step of the program instructions further comprises transmitting the well-crafted packet comprising a ping packet.

23. The system of claim 13, wherein the transmitting step of the program instructions further comprises transmitting the well-crafted packet comprising a non-routable packet.

24. The system of claim 13, wherein the transmitting step of the program instructions further comprises transmitting the well-crafted packet selected from the group consisting of: an unknown layer-3 packet, an invalid layer-3 CRC packet, and a unknown layer-2 packet.
